(19) United States
(12) Patent Application Publication
(10) Pub. No.: US 2007/0055574 A1
(43) Pub. Date: Mar. 8, 2007

(54) Commonly available device statistics for POS devices

(75) Inventors: Craig A. Jensen, Sammamish, WA (US); Harlan Husmann, Woodinville, WA (US); Janine A. Harrison, Redmond, WA (US); Sergey I. Bykov, Redmond, WA (US); Timothy E. Belvin, Auburn, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/217,617

(22) Filed: Aug. 31, 2005

(51) Int. Cl. G06Q 30/00

(52) U.S. Cl. 705/24

(57) ABSTRACT

POS device statistics information is managed such that the information is available commonly without the device being claimed by one application during retrieval of statistics information. A helper class DeviceStatistics object facilitates storing of statistics information in a common statistic repository that may be hardware based or software based, for example an XML file. The helper class also facilitates retrieval and forwarding of the statistics information to a managing POS application employing a service object for the POS device. A Windows Service based statistics service is used to retrieve the statistics information from the common statistic repository and generate performance monitor counters. The performance monitor counters are provided to requesting applications.

### BACKGROUND

Retail devices generally refer to computing devices that are used in retail sales and inventory operations. The wide variety of retail devices ranges from cash registers to handheld scanners, and from terminals to Point-Of-Sale/Service (POS) servers. To establish uniformity and coherence in communications between different retail devices, a number of standards have been developed. Ole for Point of Sale/Service (OPOS), JavaPOS, and the relatively recent UnifiedPOS (UPOS) specifications are examples of such standardization attempts.

Applications managing POS devices may encounter devices with native service objects (SOs) or legacy devices, which are not necessarily recognized by the underlying operating system. In addition to sending commands, receiving input data, and similar operational exchanges, such applications may also gather statistics information from the devices for purposes of efficient management, resource utilization, and the like.

### SUMMARY

Statistics information provided by a POS device is managed, so that more than one application may retrieve the information at the same time. A helper class object facilitates storing of statistics information in a common statistic repository that may be hardware based or software based. A software based statistic repository may include an XML file that can be stored locally or remotely.

The helper class also facilitates retrieval of the statistics information from the statistic repository and forwarding to a managing POS application employing a Service Object (SO) for the POS device. A statistics service is employed to retrieve the statistics information from the common statistic repository and to generate one or more performance monitor counters. The performance monitor counters are then provided to requesting applications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device that may be used according to an example embodiment;

FIG. 2 illustrates an example POS statistics system, where one example embodiment may be implemented;

FIG. 3 illustrates a general system diagram of managing statistics data of a POS device;

FIG. 4 illustrates interactions between different components of a POS retail system when managing statistics associated with a POS device;

FIG. 5 illustrates interactions between components of a POS retail system managing statistics, according to aspects;

FIG. 6 illustrates interaction between a POS system and the Common Control Library (CCL);

FIG. 7 shows example helper classes and Service Object (SO) repositories within the .NET framework (in WIN32 platform); and

FIG. 8 illustrates a process for managing statistics associated with a POS device.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Throughout the specification, the following terms are defined as follows, unless the context clearly dictates otherwise. The term “OPOS” refers to Ole for Point of Sale or Service. The term “UPOS” refers to the Unified Specification for Point of Sale or Service. The term “COM” refers to Component Object Model. The term “POS Class Peripheral” or “OPOS device” refers to the collection of devices that fall into one of 24 different device classes as defined in the UPOS V1.8 specification. The term “device class” is a category of POS devices that share a consistent set of properties, methods, and events. Examples are Cash Drawers and POS Printers. Some devices support more than one device class. For example, some POS Printers include a Cash Drawer. The term “control object (CO)” refers to an object that exposes the set of properties, methods, and events to an application for a specific device class. The term “service object (SO)” refers to an object that implements the UPOS prescribed functionality for a specific device. An SO can be implemented in any programming language. The term “unsupported device” or “non-supported device” refers to any device that is not, by default, supported by the UPOS operating system.

Technical standards for POS devices and applications define a specification for how POS devices can expose statistics to applications. These specifications provide the interface definition for how and when a POS application can query a POS device for a given set of statistics.

Some POS standards require that applications be granted exclusive access to a device before statistics can be read. This precludes more than one reader at a time. It also precludes access to the statistics while the device is in use.

Some standards do not specify a means for statistics to be persisted so they can be backed or and/or transported to other machines. Other standards provide no means for accessing statistics from remote machines. Furthermore, there may be no provision to provide historical device statistic information within a POS standard.

Illustrative Operating Environment

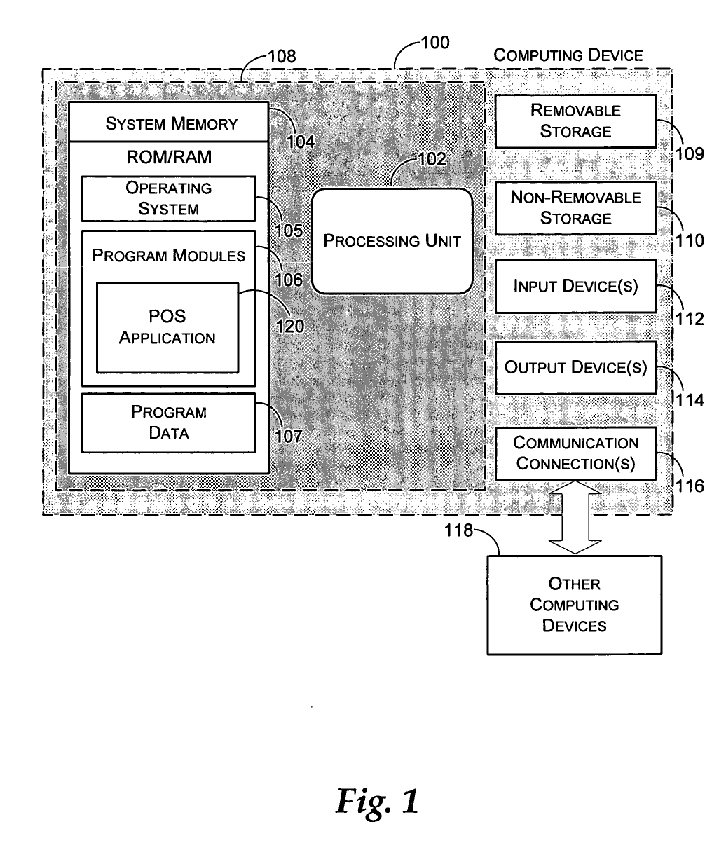

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105, one or more program modules 106, and may include program data 107. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In one embodiment, program modules 106 further include POS application 120, which is arranged to communicate with legacy and non-legacy POS devices, manage operation of such devices, receive data from the POS devices, gather statistics information from the POS devices, and the like. POS application 120 may interact with other computing devices through communication connection(s) 116.

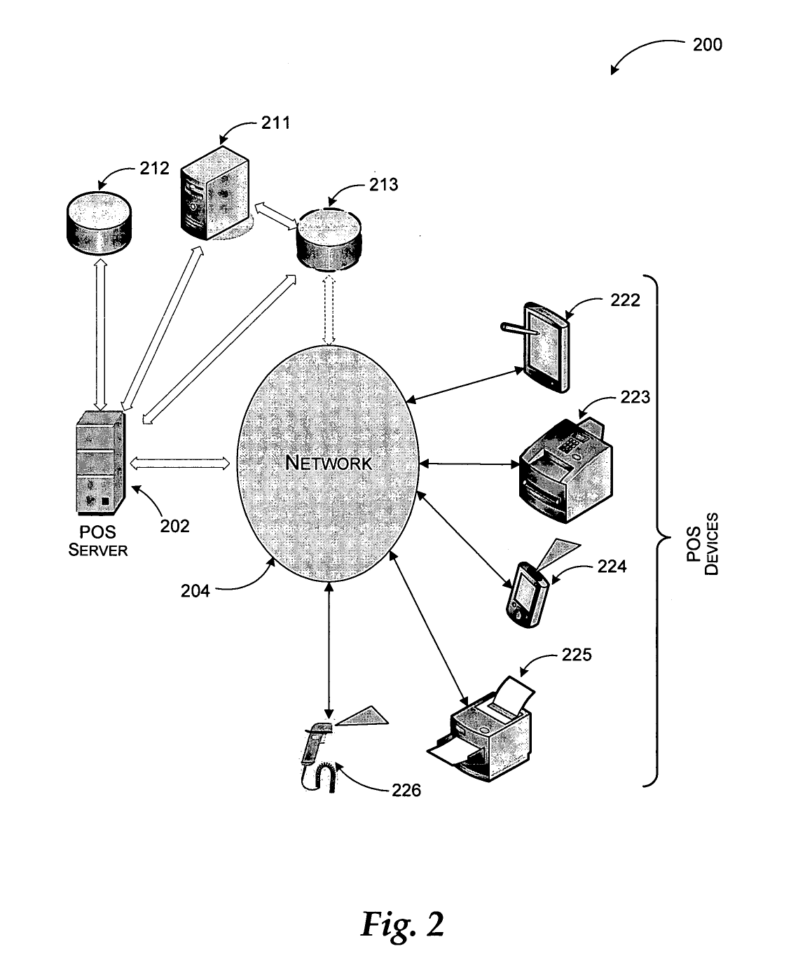

FIG. 2 illustrates example POS statistics system 200. System 200 may comprise any topology of servers, clients, Internet service providers, and communication media. Also, system 200 may have a static or dynamic topology.

System 200 includes at least one POS server 202, which provides services to other nodes of network 204 that may include client devices 222-226 directly connected to network 204. Client devices 222-226 include PDA 222, cash register 223, handheld terminal with scanner 224, printer 225, and handheld scanner 226. In one embodiment, nodes of network 204 may further include other devices (not shown), which are connected to network 204 through a subnet managed by another POS server (not shown). Services provided by POS server 202 may include an application that manages POS devices 222-226, receives data from the POS devices, processes and shares the data with other resources, and the like.

POS devices that may utilize embodiments described herein are not limited to the example POS devices 222-226. In some embodiments, the POS devices may include at least one of: a bump bar; a cash changer; a cash drawer; a credit authorization terminal; a coin dispenser; a fiscal printer; a hard totals; a keylock; a bar code scanner; a tone indicator; a motion detector; a line display; a magnetic ink character recognition reader; a magnetic stripe reader; a PIN pad; a point card reader/writer; a POS keyboard; a POS printer; a POS power; a remote order display; a scale; a signature capture; a smart card reader/writer; and a check image scanner.

POS server 202 may share data with other applications residing on other servers and client devices such as server 211. POS server 202 may also store and retrieve data associated with the POS devices in remote storage facilities such as database 212.

Furthermore, POS server 202 may gather statistics data from POS devices and store in a statistics repository (213) such as a structured document, a database, and the like. Such a repository may be maintained in POS server 202 or in another device. In one embodiment, statistics repository 213 may receive data from POS server 202, directly from the POS devices through network 204, and be accessed directly by other devices such as server 211.

Network 204 may be a secure network such an enterprise network, or an unsecure network such as a wireless open network. Network 204 provides communication between the nodes described above. By way of example, and not limitation, network 204 may include wired media such as a wired network or direct-wired connection, and wireless media such as acoustic, RF, infrared and other wireless media.

Illustrative Embodiments For Managing Statistics Data From POS Devices

Embodiments are related to managing statistics data from POS devices and making the data commonly available for consumption.

According to one embodiment, a managed class is provided that can be used by device manufacturers to satisfy the UPOS device statistics requirements. The managed class enables a POS application to interact with a common statistic repository. The statistic repository may be a common XML file that can easily be backed up and/or copied to other computing devices.

Furthermore, data from the common statistic repository is exposed as performance monitor counters. Thus, the statistics is not only exposed to POS applications via the UPOS interface, but also to other application through performance monitor counters that can be queried without requesting exclusive access to the device. This enables multiple applications to read statistics concurrently even when the POS device is in use.

Moreover, performance monitor counters can be recorded/saved in a time context. Thus historical information is also saved. Performance monitor counters may be accessed from remote machines. This allows remote monitoring applications to monitor and respond to changes in device statistics.

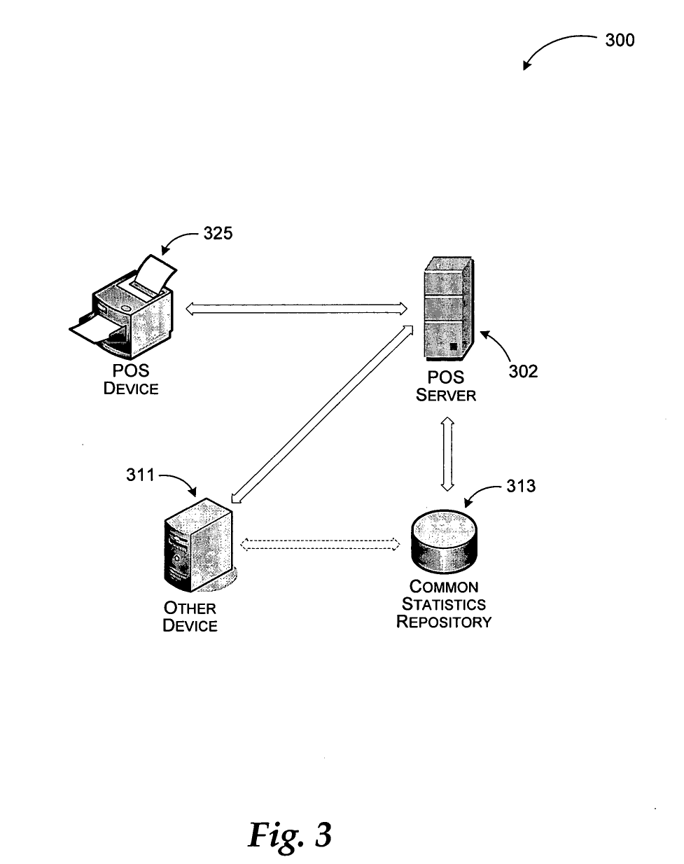

FIG. 3 illustrates system 300 managing statistics data of a POS device, in accordance with aspects of the present disclosure.

POS device 325, a POS printer, is managed by a POS application residing on POS server 302. As part of its operation, the POS application requests statistic information from POS device 325, which is stored in common statistic repository 313 as described in more detail below.

The statistic information saved in common statistic repository 313 is made available directly to the POS application residing on POS server 302. Additionally, the statistic information is made available as performance monitor counters to other applications residing on other devices 311.

In one embodiment, other applications may retrieve statistic information through the POS application or from common statistic repository 313 as performance monitor counters. This enables accessing of the statistic information by multiple applications without the POS device or the statistic repository being exclusively claimed by an application.

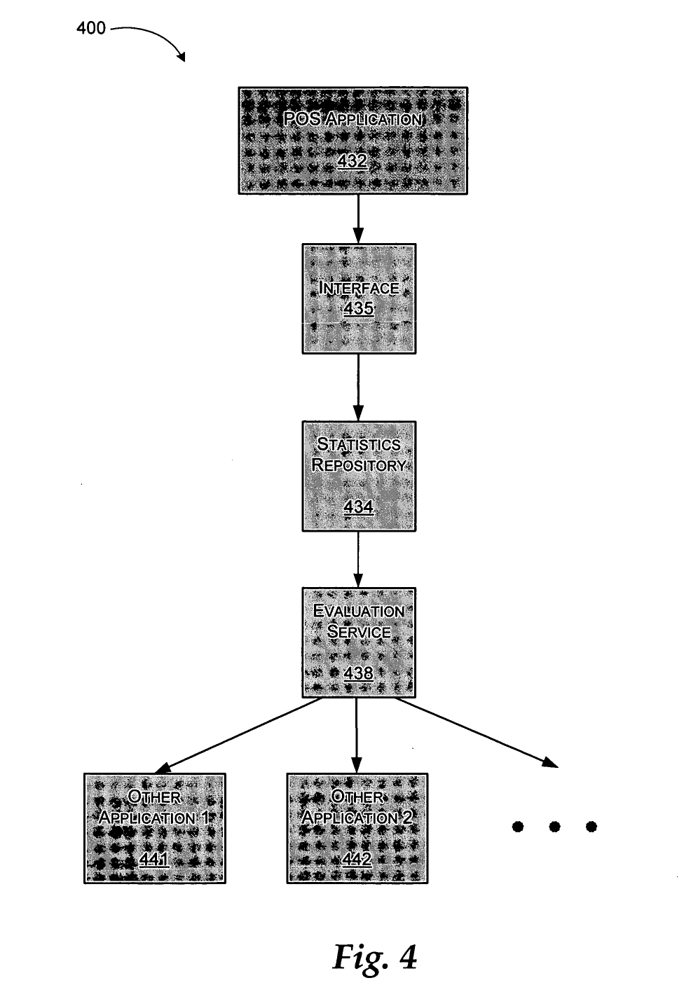

FIG. 4 illustrates interactions between different components of POS retail system 400 when managing statistics associated with a POS device.

POS application 432 interacts with statistic repository 434, which is a software based or hardware based storage medium for POS device statistics. Device statistics can be divided into two categories: (1) device information statistics and (2) device statistics. Device information statistics are properties of the device such as its name, manufacturer, version, etc. Device statistics typically reflect device usage information such as the number of hours it has been powered on, etc. UPOS 1.8 defines a set of statistics that all devices should support as well and statistics for each device class. UPOS also specifies that devices can support manufacturer specific device statistics.

To request and receive device statistics or set parameters for device statistics of the POS device, POS application 432 interacts with statistic repository 434 through interface 435. Interface 435 may include one or more modules such as a device-dependent SO, a specific helper class, and the like. The interaction is described in more detail below.

Statistic information stored in statistic repository 434 may also be accessed by other applications such as other application 1 (441), other application 2 (442), and the like. To access the information without claiming the POS device and making it unavailable to other applications, other applications may retrieve statistic information through a service called evaluation service 438.

In one embodiment, evaluation service 438 may be a Windows Service such as Statistics Service. By enabling other applications to access statistic repository 434 through a separate service, it is no longer necessary for POS application to be active while the other application is retrieving statistic information. Moreover, a number of applications that can access the statistic information simultaneously depends on the ability of evaluation service 438 to handle multiple requests increasing an efficiency of the system.

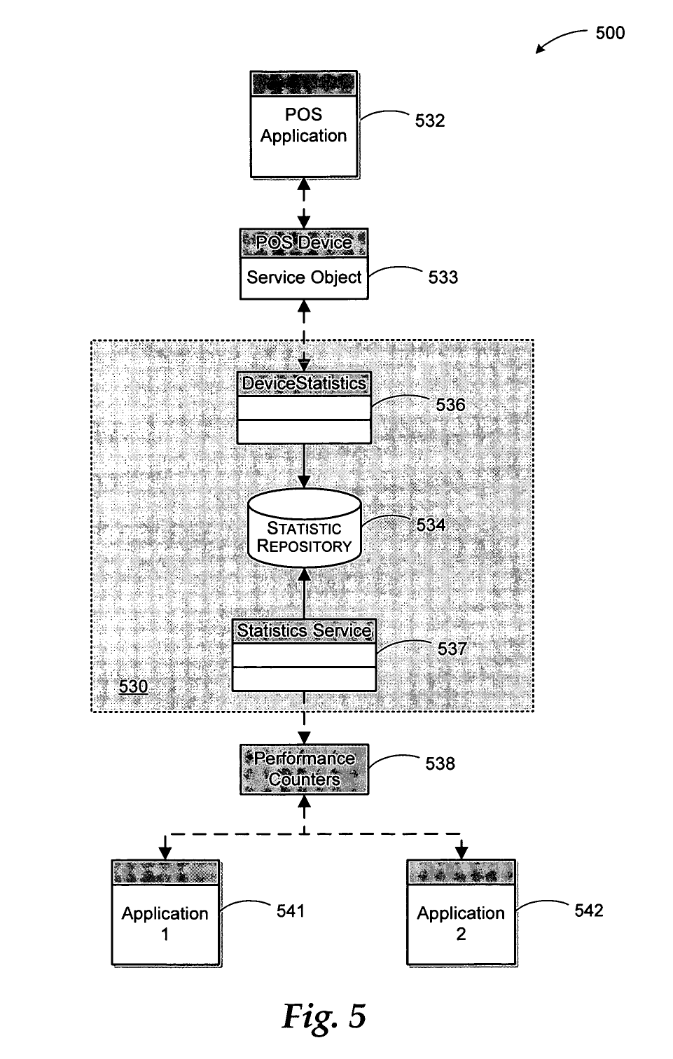

FIG. 5 illustrates interactions between components of POS retail system 500 managing statistics associated with a POS device.

POS application 532 interfacing through POS device SO 533 may request statistic information from the POS device. DeviceStatistics class 536 facilitates providing the device statistics to POS application 532.

A DeviceStatistics helper class is a .NET class that eases the burden of implementing device statistics as defined in the 1.8 version of the UPOS specification. It is included in the GenericSO implementation so SO's that derive from the GenericSO write only a very minimal amount of code to support statistics. Typically, the only code included is to call the IncrementStatistic(string Name) method to increment the value of a given statistic at the appropriate time. The GenericSO takes care of the rest of the details.

DeviceStatistics class 536 supports statistics that are stored in either hardware or software. Software based statistics may be automatically persisted to an XML file at an application definable interval and are automatically loaded from this file when the device is claimed. DeviceStatistics 536 implements each of the 3 methods (resetStatistics, retrieveStatistics, and updateStatistics) as well as the two properties (CapStatisticsReporting and CapUpdateStatistics). It also includes public helper methods for creating statistics, incrementing statistics, and loading/saving statistics to disk. To support statistics that are stored in the device itself, a callback function is specified by the SO that returns the value of the statistic. The DeviceStatistics class may call this function each time the client application requests that statistic.

In one embodiment, DeviceStatistics 536 includes an internal thread that periodically flushes statistics information to a statistic repository (534). It also reads information from statistic repository 534 on initialization so statistic values are preserved across sessions.

Statistic repository 534 is a common repository for storing device statistic information. Statistic repository 534 may be implemented as a hardware storage medium, a software storage medium such as a file, and the like. In one embodiment, an XML file may be used to store statistic information. An example of such an XML file is included below. The XML schema contains the name of the device and its hardware path so that statistics for multiple instances of the same device can be tracked.

### EXAMPLE STATISTICS XML FORMAT

<Devices>

Device Name=“Microsoft Msr Simulator”

HwPath=“21122399219248691721062221731881982371661299”>

<Statistic Name=“InstallationDate” Value=“2005-02-09” />
<Statistic Name=“CommunicationErrorCount” Value=“0” />
<Statistic Name=“ManufacturerName” Value=“Microsoft Corporation” />
<Statistic Name=“ManufactureDate” Value=“2004-05-23” />
<Statistic Name=“Interface” Value=Other”/>
<Statistic Name=“ModelName” Value=“Msr Simulator” />
<Statistic Name=“UnreadableCardCount” Value=“0” />
<Statistic Name=“FailedReadCount” Value=“0” />
<Statistic Name=“SerialNumber” Value=Unknown” />
<Statistic Name=“MechanicalRevision” Value=“1.0” />
<Statistic Name=“UnifiedPOSVersion” Value=“1.8” />
<Statistic Name=“HoursPoweredCount” Value=“0” />
<Statistic Name=“GoodReadCount” Value=“0” />
<Statistic Name=“DeviceCategory” Value=“MSR” />
<Statistic Name=“FirmwareRevision” Value=“Unknown” />

</Device>
<Device Name=“Microsoft CashDrawer Simulator”

HwPath=“2257663172512614619831221915713111946162”>

<Statistic Name=“InstallationDate” Value=“2005-02-09” />
<Statistic Name=“CommunicationErrorCount” Value=“0” />
<Statistic Name=“HoursPoweredCount” Value=“0” />
<Statistic Name=“DeviceCategory” Value=“CashDrawer” />
<Statistic Name=“FirmwareRevision” Value=“Unknown” />

</Device>

</Devices>

In another embodiment, a software based means for exposing statistic information from the common repository to other applications may be included. The means for exposing statistic information may be a Windows® Service such as Statistics Service 537 that monitors the statistics repository. When a change is detected the statistic information is read and performance monitor counters 538 are created and/or updated. Performance monitor counters 538 can easily be read from local or remote monitoring applications such as application 1 (541) and application 2 (542).

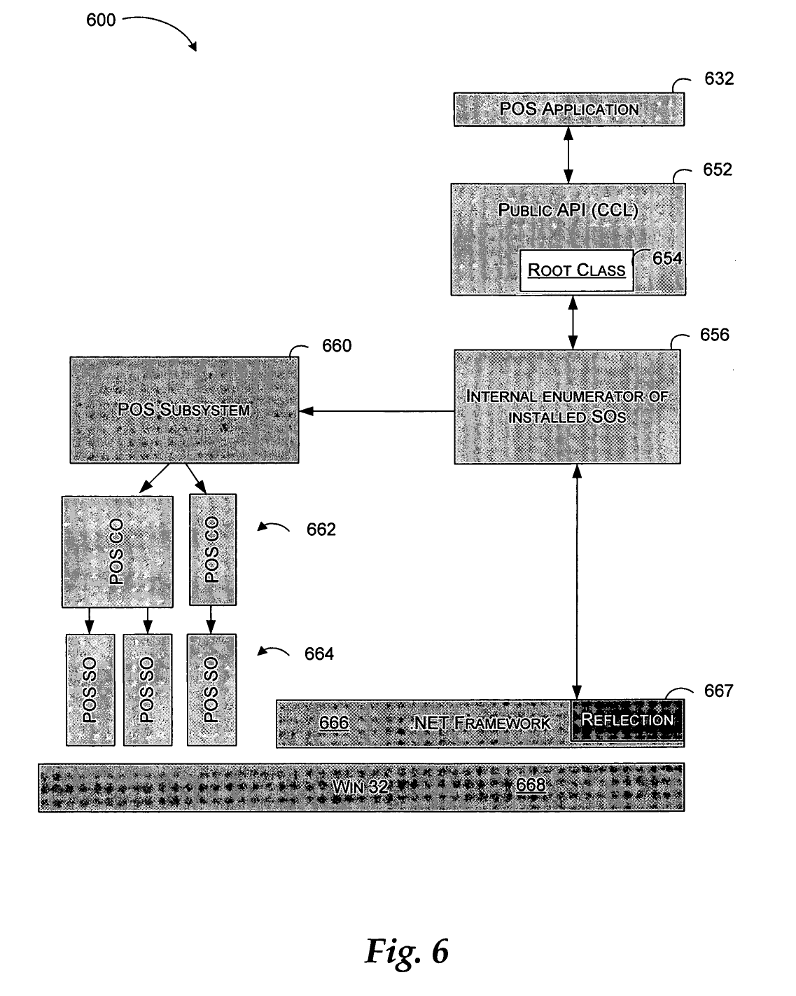

FIG. 6 illustrates interactions between a POS system and the Common Control Library (CCL).

A number of technical standards have been developed for communication with POS devices. UPOS, OPOS, JavaPOS, are some examples with .NET POS the newest addition to the POS standards. Widely implemented OPOS standard employs COM technology for communication between applications and POS devices. OPOS standard may be viewed as a specific case of the more general UPOS standard, which defines an architecture where the interface to a POS device consists of two software modules: a Control Object (CO) which acts as a device-independent interface between the application and the device, and a Service Object (SO) which acts as a device-dependent interface between the corresponding CO and the device itself.

In order to expose the interface of a SO, the library wraps legacy COM-based CO/SO pair with a managed proxy class. The proxy instantiates the SO's control object via reflection and relays application calls between the application and CO. The proxy communicates to the interface of the CO, which in turns communicates with the interface of the SO.

The CCL defines base classes for proxies, one per supported device type. If the device is a legacy device (e.g. LegacyScanner), the classes derive from the non-legacy (i.e. native .NET) interface classes. For example, LegacyScanner derives from Scanner.

While specific standards and architectures are used throughout the specification for illustration purposes, embodiments are not so limited. Other architectures may also be employed in implementing a method for managing POS device associated statistics.

Referring to FIG. 6, system 600 includes POS application 632, public API (CCL) 652, root class 654, enumerator 656, reflection 667, POS subsystem 660, POS CO's 662, POS SO's 664, and a .NET framework and Win 32 level (666 and 668).

CCL 652 wraps POS SOs with a managed proxy class. The proxy instantiates SO's control object via reflection 667 and relays application calls to it. The proxy does not directly talk to the actual SO (664). Instead it communicates with its CO (662).

The CCL (652) consists of three core assemblies: (1) POS.Interfaces.dll which defines interfaces, enums, and constants and is referenced by both SOs and applications; (2) POS.dll contains POS.Root class which lets applications (ISV) enumerate and instantiate service objects for installed POS devices; and (3) GenericServiceObject.dll is a base class for a service object. Writers of service objects (IHV) may be encouraged to derive from it and leverage its default implementation of basic SO functionality like event queue, global claim, etc.

Since the three assemblies are referred from multiple places on the POS machine hard drive, the assemblies are installed in the Global Assembly Cache. This helps to ensure that only one copy of the binaries is used across the machine and that the binaries can be serviced in one centralized place.

Several interfaces are defined for the purpose of creating managed Service Objects. These interfaces encapsulate the POS 1.8 specification and are divided into two categories: (1) device class independent interfaces that model common POS functionality; and (2) device dependent interfaces that model functionality specific to a given class of devices.

Publicly exposed POS interfaces (common and device dependent ones) are defined in a separate assembly POS.Interfaces.dll. These interfaces are implemented by .NET service objects. Applications cast SO instances received from the CCL to these interfaces to access specific functionality of particular device classes. Base control interfaces are defined in POS.Interface.Basic namespace and have the following hierarchy. IPOSControl is a base interface for .NET service objects. SOs implement it directly or indirectly. The library uses pointers to this interface for SOs and applications cast it to more specific device dependent interfaces like IMSR, IPOSPrinter, etc. IPOSEventInput extends IPOSControl by adding three properties for SOs for event driven input devices. IPOSAsyncOutput extends IPOSControl by adding OutputID property for SOs for devices that support asynchronous output (like printers).

Device dependent interfaces for standard OPOS device classes are defined in POS.Interfaces. Specific namespace. They derive from one of the above base interfaces and extend them with functionality specific for particular device classes. IHV's derive from these interfaces when implementing their SO's. Example interfaces are as follows: ICashDrawer for cash drawer; IMSR for magnetic stripe reader; IPOSPrinter for receipt printer; and the like.

The interfaces have IPOSControl as their parent/grandparent, so any SO can be cast to IPOSControl interface. The library classes operate with IPOSControl interfaces and applications cast instances of SOs to the device specific interfaces. That allows introducing new device classes without changing the library. As long as the new device class interface is derived from IPOSControl, the library is able to handle SO instances for the new device class.

CCL 652 communicates with POS application 632 and exposes an enumerator of available POS devices. The library serves as a factory for instantiating instances of service objects. It decouples writers of POS applications from implementation of specific service objects and is a single entry point for applications for interacting with POS devices.

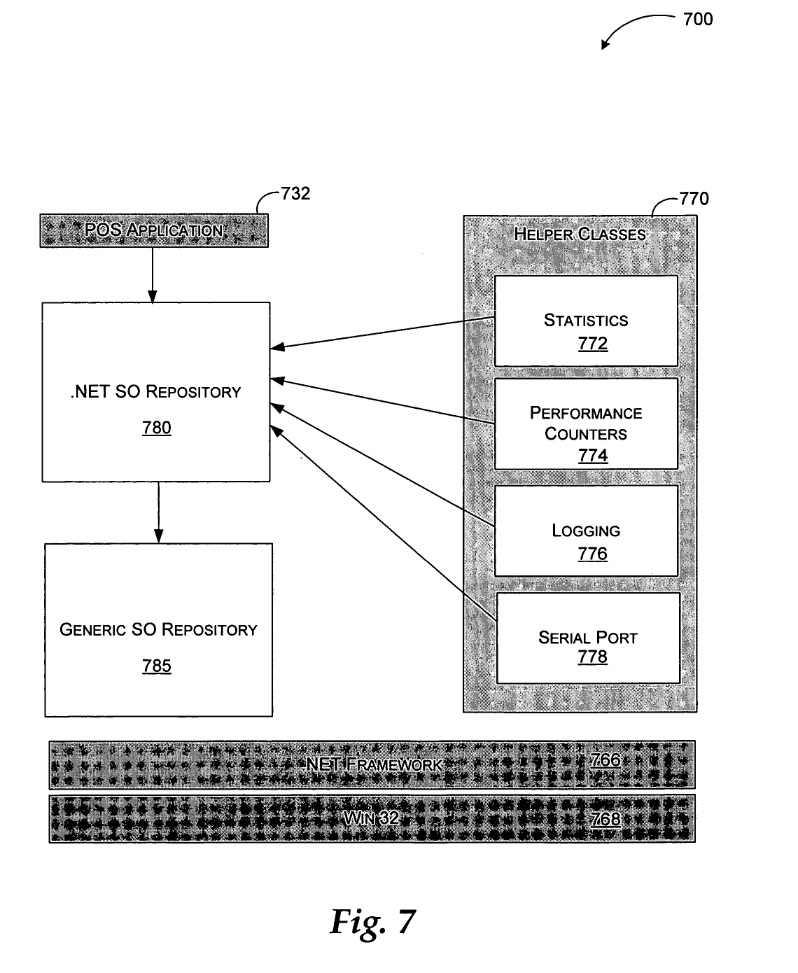

FIG. 7 includes diagram 700 illustrating example helper classes and Service Object (SO) repositories within .NET framework 766 (in WIN32 platform 768). POS application 732 talks to SO's in .NET SO repository 780.

A set of helper classes (770) is provided to help independent hardware vendors implement performance counters and device statistics in a simple and consistent manner.

Hardware vendors typically implement a device dependent SO that implements an interface as described in the POS specification and talks directly with their hardware. The CCO.Net library includes several technologies that ease the burden to produce high quality implementations of SO's, including: support for writing Service Objects in managed code; a generic implementation of the POS features common to most service objects. This includes infrastructure for device claiming/enabling, eventing, queuing of messages, statistics, etc. IHV's can leverage this object to relieve much of the burden of implementing the POS specific aspects of SO's allowing them to concentrate on the device specific details and the set of helper classes (770) for performance counters 774, device statistics 772, logging 776, serial port 778, etc.

According to one embodiment, service objects are written as .NET assemblies. These assemblies derive from the IPOSControl interface or one of the device specific interfaces defined which derive from IPOSControl. These assemblies include assembly-level and class-level attributes that describe the device class(es), POS versions and the hardware Id(s) of the supported devices. The CCO.Net library uses these attributes to determine which of the device classes the SO implements and what hardware it controls. By using assembly attributes installation of SOs is significantly simplified because the assembly can simply be copied into a directory where the CCO.Net can find it.

Generic SO repository 785 includes generic service object class, which is an abstract base class that implements the default functionality required by service objects of all device classes. The typical scenario would be for IHV's to derive from the generic service object and one of the device specific interfaces. By doing this IHV's can rely on the generic service object to handle many of the POS specific details and can concentrate their efforts on the device specific aspects of the SO.

The generic service object class contains a default implementation for the methods and properties on the IPOSControl interface. This includes a mechanism for event queuing and delivery, device state management (claiming, enabling, etc.) and state reporting. Since this is an abstract class it cannot be directly instantiated and is intended solely for IHV's to derive their SO's from. The methods and properties are marked as virtual so IHV's can use the default implementations and override any methods that they see fit.

The generic service object implements the details of POS event delivery in the form of an event queue, event queue worker thread and various synchronization objects. The event queuing data structures are created and initialized when the Open( ) method is called. The Close( ) method releases the device, terminates the event thread and cleans up the internal objects. A set of helper classes is provided to help IHV's implement performance counters and device statistics in a simple and consistent manner.

As mentioned previously, the DeviceStatistics helper class eases the burden of implementing device statistics. It is included in the GenericSO implementation. The DeviceStatistics class can support statistics that are stored in either hardware or software. Software based statistics may be automatically persisted to file, such as an XML file, at an application definable interval and are automatically loaded from this file when the device is claimed. To support statistics that are stored in the device itself, a callback function may be specified by the SO that returns the value of the statistic. The DeviceStatistics class calls this function each time the client application requests that statistic.

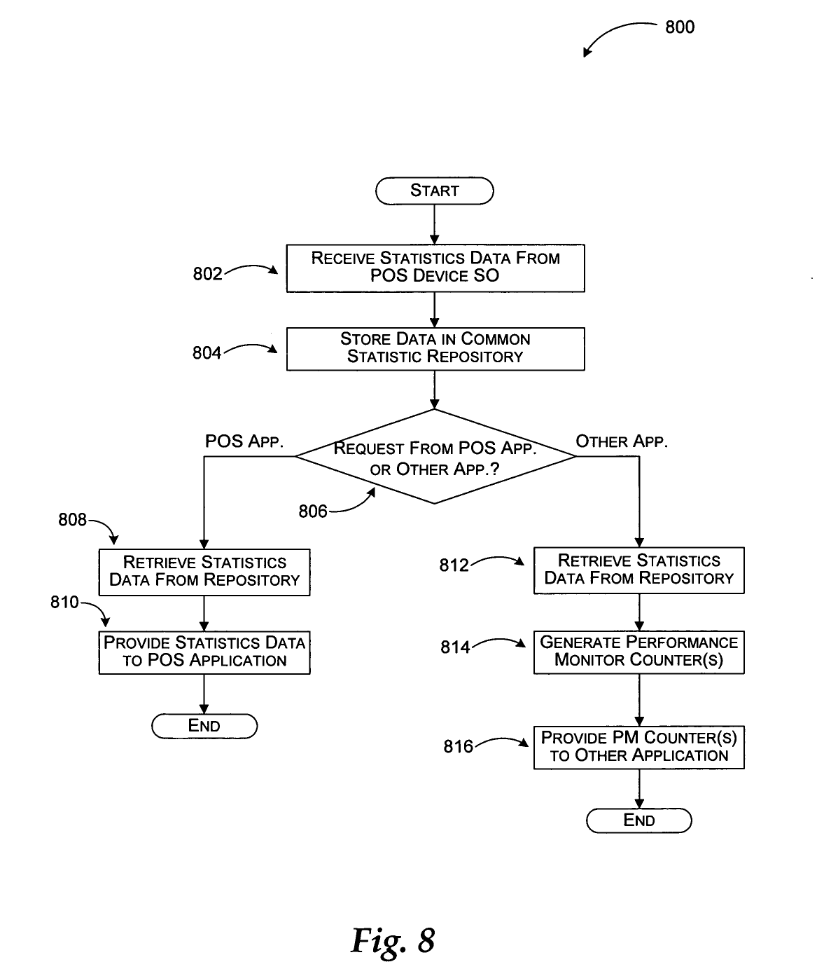

FIG. 8 is a logic flow diagram illustrating process 800 for managing statistics data from POS devices.

Process 800 begins at block 802, where statistics data is received from a POS device through the POS device SO. The statistics data may be provided periodically by the device, upon request, upon change of a predetermined status, and the like. Processing advances from block 802 to block 804.

At block 804, the statistics data is stored in a common statistics repository. As mentioned before, the statistics repository may be hardware based or software based. In the case of software based repository, a file, such as an XML file, may be used to store the data. In one embodiment, a helper class, DeviceStatistics, may store the data in the statistics repository. Processing proceeds from block 804 to decision block 806.

At decision block 806, a determination is made whether statistics data is requested by the POS application itself or by another application. If the POS application is requesting the statistics, processing moves to block 808. If another application is requesting the statistics, processing advances to block 812.

At block 808, the statistics data is retrieved from the statistics repository. Processing then moves to block 810, where the statistics data is delivered directly to the POS application for further processing. After block 810, processing moves to a calling process for further actions.

At block 812, the statistics data is retrieved from the statistics repository similar to block 808. Processing then advances to block 814.

At block 814, performance monitor counters are generated by a service such as Windows(& based Statistics Service. Performance monitor counters can be used by a wide variety of applications for statistical data processing purposes without the original application having to access the source POS device. Processing proceeds from block 814 to block 816.

At block 816, the performance monitor counters based on the retrieved statistics data are delivered to the requesting application for further processing. After block 816, processing moves to a calling process for further actions.

The blocks included in process 800 are for illustration purposes. Managing of POS device statistics data may be implemented by a similar process with fewer or additional steps including allowing other applications to access the statistics repository directly.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for managing statistics information associated with a Point-Of-Sale/Service (POS) device, comprising:
receiving the statistics information associated with the POS device;
storing a first set of data associated with the statistics information in a common statistic repository; and
retrieving the first set of data from the common statistic repository for delivery to one of a POS application managing the POS device and another application.

2. The method of claim 1, further comprising generating a second set of data based on the first set of data; and providing the second set of data to the other application.

3. The method of claim 2, wherein the second set of data includes performance monitor counters.

4. The method of claim 1, wherein a device dependent Service Object (SO) is employed to receive the statistics information from the POS device.

5. The method of claim 1, wherein the first set of data is retrieved periodically from the common statistic repository.

6. The method of claim 1, wherein the first set of data is retrieved upon one of a request and a change of statistic information from the common statistic repository.

7. A system for managing statistics information associated with a POS device, comprising:
a POS application configured to manage the POS device;
an object configured to store the statistics information in a common statistic repository, and provide the statistics information to the POS application; and
a statistics service configured to retrieve the stored statistics information, generate a performance monitor counter based on the statistics information, and provide the performance monitor counter to a requesting application other than the POS application.

8. The system of claim 7, further comprising a Service Object (SO) that is associated with the POS device, wherein the SO is configured to facilitate a communication between the POS application and the POS device.

9. The system of claim 7, wherein the statistics service is a Windows Service that is configured to retrieve the stored statistics information upon one of: an expiration of a predetermined period, a request, and a change in the stored statistics information.

10. The system of claim 9, wherein the statistics service is configured to retrieve the stored statistics information such that the POS device is not claimed during the retrieval of the statistics information.

11. The system of claim 7, wherein the object is a helper class object that is further configured to retrieve the stored statistics information upon one of: an expiration of a predetermined period, a request, and a change in the stored statistics information.

12. The system of claim 7, wherein the common statistic repository is one of: hardware based and software based.

13. The system of claim 12, wherein the software based common statistic repository is an XML file.

14. The system of claim 7, wherein the POS device includes at least one of: a bump bar; a cash changer; a cash drawer; a credit authorization terminal; a coin dispenser; a fiscal printer; a hard totals; a keylock; a bar code scanner; a tone indicator; a motion detector; a line display; a magnetic ink character recognition reader; a magnetic stripe reader; a PIN pad; a point card reader/writer; a POS keyboard; a POS printer; a POS power; a remote order display; a scale; a signature capture; a smart card reader/writer; and a check image scanner.

15. The system of claim 7, wherein the object and the POS application are .NET based.

16. A computer-readable medium having computer instructions for managing statistics information associated with a POS device to be commonly available, the instructions comprising:
storing a first set of data associated with the statistics information related to the POS device in a common statistic repository;
retrieving the first set of data from the common statistic repository upon at least one of: an expiration of a predetermined period, a request, and a change in the stored statistics information;
if the statistics information is to be provided to a POS application managing the POS device, providing the first set of data to a Service Object associated with the POS device; and
if the statistics information is to be provided to a another application, generating a performance monitor counter based on the first set of data, and providing the performance monitor counter to the other application.

17. The computer-readable medium of claim 16, wherein the instructions further include:
receiving the first set of data from the POS device through the Service Object associated with the POS device.

18. The computer-readable medium of claim 16, wherein the common statistic repository is a structured document.

19. The computer-readable medium of claim 16, wherein the instructions further include:
transmitting a command associated with gathering of the statistics information to the POS device through the Service Object.

20. The computer-readable medium of claim 19, wherein the command is in response to retrieved first set of data.
